(19) United States
(12) Patent Application Publication
(10) Pub. No.: US 2009/0133022 A1
(43) Pub. Date: May 21, 2009

(54) Multiprocessing apparatus, system and method

(76) Inventor: Faraydon O. Karim, Round Rock, TX (US)

Correspondence Address: PETER MARTINEZ, P.O. BOX 131313, CARLSBAD, CA, 92013, US

(21) Appl. No.: 11/985,481

(22) Filed: Nov. 15, 2007

(51) Int. Cl. G06F 9/46

(52) U.S. Cl. 718/102; 718/100

(57) ABSTRACT

An apparatus to isolate a main memory in a multiprocessor computer is provided. The apparatus include a master processor and a management device communicating with the master processor. One or more slave processors communicate with the master processor and the management device. A volatile memory also communicates with the management device and the main memory communicating with the volatile memory. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to multiprocessing, and, more specifically, to multiprocessing design methodology and computer software programs for multiprocessors.

### BACKGROUND OF THE INVENTION

Modern computers were first made with relay switches, then vacuum tubes, and now transistors. Early programming consisted of plugging cables in specific patterns and throwing switches. That became tedious, and researchers came up with the idea of storing program instructions in memory. That idea is still used today and modern computers are actually a blend of programming through hard wiring, and programming through the stored program method.

In a stored program computer individual commands (operation codes) are stored in sequential memory locations and read one at a time by the computer's Central Processing Unit (CPU). The commands are thought of as operation codes (opcodes). Imagine that the CPU has a separate hard wired circuit for each possible opcode. One by one, each opcode is read from memory, and the CPU invokes a different hard-wired circuit depending on what the opcode is. That is like plugging and unplugging cables, except the CPU does it for you, using switches instead of plugs.

In the stored program model, a program (the micro instruction set) is stored as data consisting of instructions for the computer to follow. The instructions are read sequentially from the memory where they are stored. A Program Counter (or Instruction Pointer) holds the address of (i.e., points to) the instruction being read, and is incremented to the next instruction after the instruction is read from memory.

This is called an execution thread (or simply thread). The program is called a process and can have more than one thread. A thread only exists within its process. The threads of a process share the same process resources, as peers, allowing ease of communication between threads. A thread has access to all of the memory in the process, and the stacks of all other threads that are in the process.

Each thread has own Instruction Pointer. Consider for a moment only a single thread. The instructions are read sequentially, but are not necessarily executed in that order. Some processors use a technique called pipelining in which an instruction starts executing before a previous instruction finishes execution. The previous instruction may take a long time and the next instruction could actually finish first. In addition, there are variations.

For example, to increase efficiency a compiler could change the order of execution of the source code (i.e., static optimization) without disrupting dependencies between variables: quicker instructions could be batched together from nearby code if other variables are not affected. Or in dynamic scheduling, hardware instruction buffers are used, where instructions wait for their source operands to become available.

Source code is a computer program as written by a programmer using a high level language (such as C++, Basic, Java, etc.) that are now more widely used than assembly language (which uses the computer's macro instruction set of opcodes). The source code is converted into opcode instructions in a process called compilation, which is performed by programs that are called compilers.

After execution, the instructions are committed (reordered to original order) in case an interrupt has to be processed. And so the actual order of execution is irrelevant, because dependencies were tracked while the instructions were out-of-order. But this is only true within a thread. Dependencies between threads are not tracked. It is up to the programmer to track dependencies between threads.

Multi-threaded programs previously developed for single processor systems (in which all threads run on the same processor, or CPU) generally behave differently when run on multiprocessor systems (i.e., multiple CPUs), in which case the secondary threads could run faster instead of slower than the program's main thread. This introduces new data consistency problems for the program.

Recently, multiprocessor systems have begun to flood the marketplace. To exploit the computing power of multiprocessor systems, programs originally designed for a single processor, or a single CPU, have to be rewritten for multiprocessors. Ideally, parallel processing makes a program run faster because there are more engines (CPUs) running it. In practice, it is often difficult to divide a program in such a way that separate CPUs can execute different portions without interfering with each other.

Unlike traditional single processor architectures, multiprocessing execution models require applications to be parallelized into multiple threads either by the programmer or by the compiler. However, this program parallelization generally requires inter-processor communication and synchronization, at a frequency and volume that increases as the number of threads grows. Current multiprocessors usually employ various synchronization methods but these methods impose a significant overhead of hundreds or even thousands of CPU clock cycles. As a result, the most significant problem with exploiting the additional computing power of multiprocessors is the difficulty in parallel programming, debugging and design.

Therefore, there remains a need to overcome one or more of the limitations in the above-described, existing art.

### BRIEF DESCRIPTION OF THE DRAWINGS

FIG. 1 illustrates a schematic view of one embodiment of the VPMS system in a computer environment;

FIG. 2 illustrates a schematic view of a computer program sequence;

FIG. 3 illustrates a schematic view of a computer program sequence that includes a control task;

FIG. 4 illustrates a block diagram of computer program constructed according to one embodiment of the present invention;

FIG. 5 illustrates a block diagram of a portion of a process performed by the computer program constructed according to one embodiment of the present invention;

FIG. 6 illustrates a block diagram of a portion of another process performed by the computer program constructed according to one embodiment of the present invention;

FIG. 7 illustrates a block diagram of a portion of a process performed by the computer program constructed according to one embodiment of the present invention;

FIGS. 8 and 9 illustrate a flow chart of one embodiment of the VPMS system; and

FIG. 10 illustrates one embodiment of a computer program written for the VPMS system.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following description, for the purposes of explanation, numerous specific details are set forth in order to provide a thorough understanding the present invention, one embodiment of which is the Volatile Program Memory Space (“VPMS”) system and method. It will be apparent, however, to one skilled in the art that the VPMS system may be practiced without some of these specific details. Throughout this description, the embodiments and examples shown should be considered as exemplars, rather than as limitations on the VPMS system. That is, the following description provides examples, and the accompanying drawings show various examples for the purposes of illustration. However, these examples should not be construed in a limiting sense as they are merely intended to provide examples of the VPMS system rather than to provide an exhaustive list of all possible implementations of the VPMS system. For example, the VPMS system may be employed in speculative task dispatching, out-of-order task execution, fault tolerance, compilers, debuggers, system synthesis, and other applications.

Specific embodiments of the VPMS system will now be further described by the following, non-limiting examples which will serve to illustrate various features. The examples are intended merely to facilitate an understanding of ways in which the VPMS system may be practiced and to further enable those of skill in the art to practice the VPMS system. Accordingly, the examples should not be construed as limiting the scope of the invention.

Originally, computers were isolated machines, each with a single processor, or CPU that was a computer chip attached to the computer's main board. The main board was called a motherboard, and had other chips attached to it. The other chips were controlled by the CPU chip, which sent signals to the other chips via the motherboard's wiring system.

Later, another advance was made whereby a single computer could have more than one CPU chip. The different CPU chips would be on the same motherboard, and communicate with each other over the motherboard “bus” wiring. Even more efficient is to have more than one CPU on a chip, with direct on-chip wiring between those CPUs, instead of communicating through the slower and more expensive main board (bus) wiring.

The most computationally efficient is to also have other components on the chip (not just CPUs). This system-on-chip is a complete electronic system on a chip, including memory and one or more processors (i.e., CPUs or “cores”). If there is more than one processor (core) on the chip, it is said to be a multiprocessor system-on-chip (MPSoC). The MPSoC cores can be heterogeneous (not all the same), each sized for specific tasks, and do not need to be fast to perform specific tasks as fast as much larger and “faster” conventional processors, doing so at a fraction of the cost with much lower power consumption and less silicon space.

Generally, there are two types of multiprocessor architectures. One is centralized and the other decentralized. The first uses a master-slave structure where one of the processors is configured as a master or Control Processor (CP) sending tasks to the other processors which are called slaves or Processing Elements (PE). Most multiprocessors today use this architecture. The decentralized architecture employs a combination of processors on the same bus, or may use a bank of processors. In addition, there is a third architecture which pipelines processors or processing elements for a specific purpose. Embodiments of the VPMS system can be employed on any type of multiprocessor architecture.

To exploit the computing power of multiprocessor systems, programs originally designed for a single processor, or a single CPU have to be rewritten for multiprocessors. Ideally, parallel processing makes a program run faster because there are more engines (CPUs) running it. In practice, it is often difficult to divide a program in such a way that separate CPUs can execute different portions without interfering with each other.

For example, unlike traditional single processor architectures, multiprocessing execution models require applications to be parallelized into multiple threads either by the programmer or by the compiler. These threads use any idle processors so that the processors are always busy. Scheduling these threads is done by help of the operating system. Unfortunately multithreading has many side effects. There is great possibility that threads interfere with library threads and multiple thread programs are very hard to debug, greatly increasing development costs.

Regardless of the multiprocessing architecture, communication between the processors is performed via memory. A processor without a memory would not be a computer, merely a simple digital signal processing device, able to perform a fixed operation and immediately output the result. It would have to be re-built to change its behavior. The ability to store and change both instructions and data, makes computers versatile. It basically introduces the concept of computer programming, as opposed to re-building the hardware.

A computer can exist that uses a single type of storage, or memory for all data. However, to provide better computer performance at a lower cost, computers usually use a memory hierarchy that includes a variety of different types of memory. The lower the memory is in the hierarchy, the bigger is its distance from the CPU (or CPUs).

The first type of memory is processor registers that are generally the only ones directly accessible to the CPU. Generally, the CPU continuously reads instructions stored in the registers and executes them. Any data actively operated on is located in the processor registers. Each of the registers holds only several bits of data, for example 64 bits. The arithmetic and logic unit (ALU) of the CPU uses this data to carry out the current instruction. Registers are technically the fastest of all forms of computer storage, being switching transistors integrated on the CPU's chip, and function as electronic “flip-flops”.

In computing, an arithmetic logic unit (ALU) is a digital circuit that performs arithmetic and logical operations. The ALU is a fundamental building block of the CPU, and each CPU in a multiprocessor has at least one ALU. Generally, each operational step in an ALU is called a clock cycle or step.

Some processors also include a processor cache, or cache memory that may be a intermediate stage between registers and a main memory. Cache memory is generally used to increase performance of the computer. Most actively used information in the main memory is just duplicated in the cache memory, which is faster, but has a smaller capacity. Cache memory is much larger than the processor registers, but is also much slower. Cache memory may be on-chip memory that buffers data from larger off-chip memory, such as the main memory.

Another type of memory is scratch pad memory (SPM), or tightly coupled memory (TCM). SPM can be Static RAM (SRAM) or less expensive Dynamic RAM (DRAM). One use of scratch pad memory is in combination with a cache. When a CPU needs data, it looks for the data in the cache and SPM. The off-chip memory (main memory) is accessed only if the data is not found in the cache or SPM. Another type of memory is a Translation Lookaside Buffer (TLB) that is a CPU cache that is generally used by memory management hardware to improve the speed of virtual address translation. Generally, a TLB has a fixed number of slots containing page table entries, which map virtual addresses onto physical addresses. It is typically a content-addressable memory (CAM), in which the search key is the virtual address and the search result is a physical address. If the requested address is present in the TLB, the CAM search yields a match, after which the physical address can be used to access memory.

Main memory may be comprised of random access memory (RAM) in the form of SRAM, DRAM, SDRAM, DDR SDRAM, and other types of memory. Generally, a CPU sends a memory address that indicates the location of data. Then it reads or writes the data itself using the data bus. Additionally, a memory management unit (MMU) may be employed that is located between the CPU and main memory that recalculates the actual memory address, for example to provide an abstraction of virtual memory or other tasks.

The VPMS system described herein addresses the major problems of programming multiprocessors by adding a new type of memory allocation and usage. This new memory is called a functionally volatile program memory space (VPMS), that in one embodiment, is not addressable by the main memory (i.e., RAM, such as SRAM, DRAM, SDRAM, DDR SDRAM etc.), cache memory, SCM memory, TCM memory or other types of memory. Embodiments of the VPMS system free the programs and programmer from synchronization issues as well as many other problems associated with programming multiprocessors. The VPMS system can be applied to application program writing, compilers, debuggers, verification, speculative task dispatching, out-of-order task execution, fault tolerance, system synthesis, and other applications. In addition, the VPMS system can be applied to general multiprocessing systems.

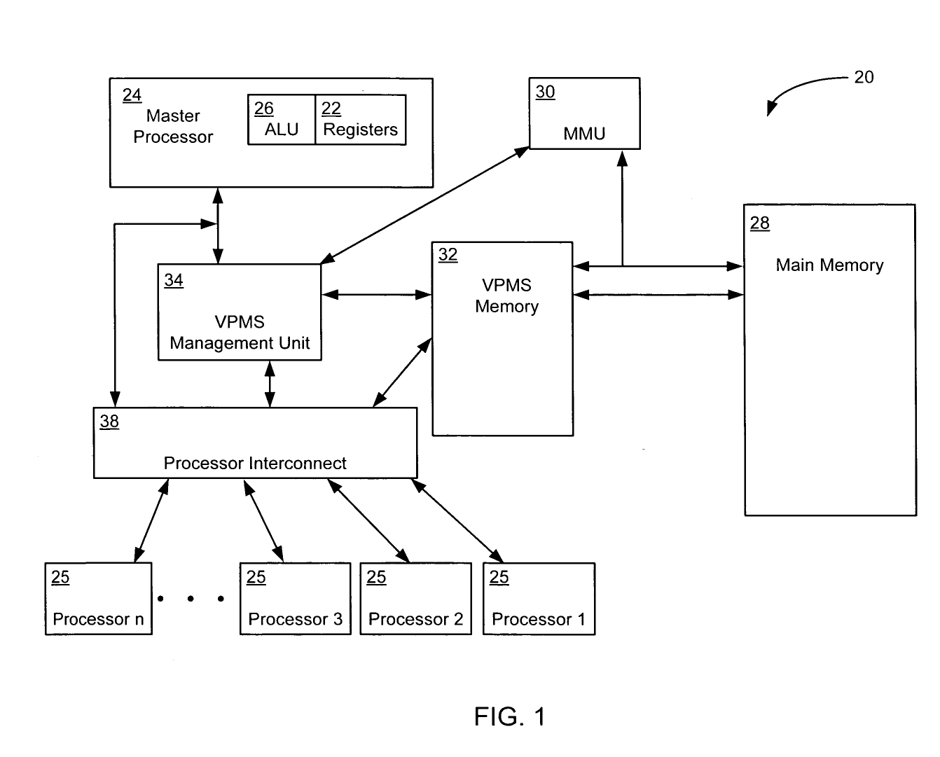

Referring now to FIG. 1, one feature of the VPMS system 20 is that all memory including main memory 28, cache, SPM, TCM and other memory, communicates with the master processor or control processor (CP) 24 through the VPMS management unit 34. The VPMS system 20 addresses the major problems of programming multiprocessors by adding a new type of memory allocation and usage. This new memory is a functionally volatile program memory space 32, that in one embodiment, is not addressable by main memory 28 (i.e., RAM, such as SRAM, DRAM etc.), cache memory or other types of memory. Thus, the VPMS system 20 is not subject to TLB processing or any kind of operating system manipulation.

That is, one feature of the VMPS system 20 is that it isolates the main memory 28 from the processors 24 and 25, and by doing so keeps the sequential consistency of a program, and enables out of order execution of tasks and speculative execution of tasks by solving data hazard issues in the task level and on large blocks of data by creating dynamically available program memory (the functionally volatile program memory space 32) for processing functions.

By keeping the sequential consistency of a program, the VPMS system 20 allows programmers to write sequential programs that can utilize the computing power of multiprocessor computers, such as MPSoC computers, and also allows programmers to write compilers for multiprocessor computers, without having to use conventional multi-processor programming techniques.

Generally, a multiprocessor is sequentially consistent if the result of any execution is the same as if the operations of all processors were executed in some sequential order, and the operation of each individual processor appears in the sequence in the order specified by its program. Maintaining sequential consistency ensures program accuracy. However, to exploit the computing power of today's multiprocessing systems, programs should be executed non-sequentially. But, once all the processors become active executing a program complexities arise because of interdependencies between program data. Thus, as described above, writing parallel programs is extremely complex.

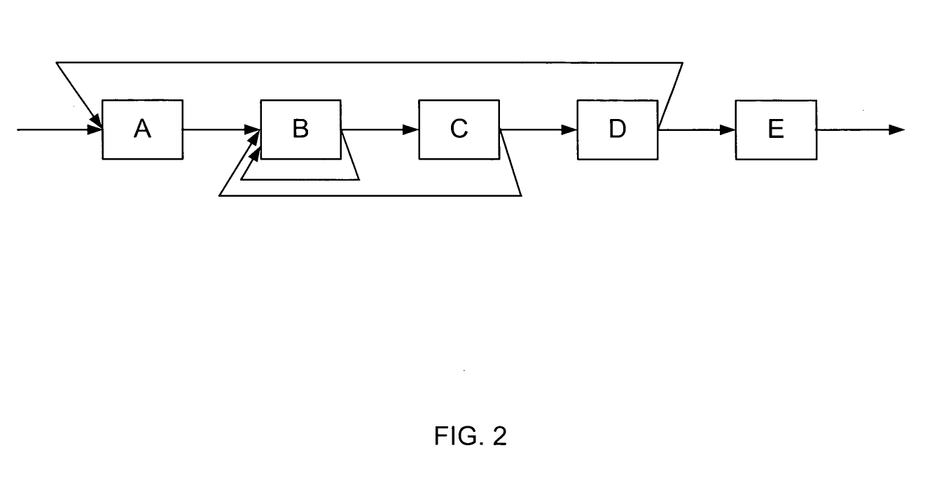

An example of sequential execution of a computer program is illustrated in FIG. 2. The program is constructed of five basic blocks, or tasks, A, B, C, D, and E. The five tasks represent a static description of the program. Suppose the dynamic sequence of the program as it is executed by the CPU is:
A|B|C|B|B|C|D|A|B|B|C|D|A|B|C|B|C|D|E.

In a sequential process, the dynamic instructions corresponding to this sequence are generated as the program control navigates through a control flow graph (CFG), executing one instruction at a time. Generally, a CFG is a representation of paths that may be traversed through a program during its execution. To ensure a correct execution by the CPU, it must appear that the instructions among all basic blocks execute in precisely this same sequential order, regardless of what actually transpires.

One embodiment of the VPMS system 20 is that it keeps the sequential consistency of a program, maintains support for memory consistency and provides an abstraction that allows programmers to write programs for multiprocessors (i.e., a parallel process) as if the program was for a single processor (i.e., a sequential process). In addition, embodiments of the VPMS system 20 provide a compiler that compiles a computer program from high level code to machine language, while maintaining parallelism. One embodiment of the VPMS system 20 may be included within a multiprocessor system-on-chip (MPSoC) architecture that includes a master processor, or control processor (CP) 24 and one or more slave, or secondary processors 25.

Referring again to FIG. 1, the VPMS system 20 is arranged to separate main memory 28, as well as cache, SPM, TCM and other memory from the master processor, or CP 24 and the secondary or slave processors 25. Generally, the master processor 24 includes one or more arithmetic logic units (ALUs) 26 and multiple registers 22. Separating main memory 28 and other memory from the processors 24 and 25 keeps the processors 24 and 25 from referencing the main memory 28 directly. The VPMS system 20 provides a different memory for the processors 24 and 25 to access and perform data processing. The new memory, called VPMS memory 32, is active and contains data during the dynamic execution of the program. That is, the data in VPMS memory 32 is volatile—it disappears when the execution of the computer program ends. In addition, VPMS memory 32 is not observable by the main memory 28. VPMS memory 32 is addressed by index only so it is differentiated from the main memory 28 and the conventional program addresses that may be located in the main memory 28.

For example, location zero in VPMS memory 32 is indexed as VPMS (0), the next location is indexed as VPMS (1), the next is indexed as VPMS (2), and so on, which is an increment by one regardless of the size of data in each location in the VPMS memory 32. That is, the physical size of each location can be practically any size, depending on the size of the VPMS memory 32, but in one embodiment, each individual VPMS memory 32 index may only have a maximum size of 8 bits, in contrast to a conventional program memory address, which may have a size ranging from 32 bits to 612 bits. It will be appreciated that the memory size of each VPMS memory 32 index may vary from 8 bits, but it will generally be significantly smaller that a conventional program memory address.

Therefore, one feature of the VPMS system 20 is that conventional program memory addresses that are located in the main memory 28 are not generated. For example, a programmer may generate a line of program code such as “read from VPMS (1), and put output in VPMS (2).” The programmer does not generate a conventional program memory address, thereby eliminating confusion with the program memory addresses located in main memory 28.

In order for a computer program to operate on data, the CP 24 loads data into one or more locations in VPMS memory 32, (with each location located by an index, discussed above) and the operation tasks are performed on data that is available from each location in VPMS memory 32. The VPMS memory 32 is internally structured to include data, a processor identification (either CP 24 or one or more slave processors 25), a data size, and may also include information about whether the location is private or public. A location becomes private when it is assigned to a specific processor 25, or to a task by VPMS-MU 34, or when a processor 25 which executes a task writes to that specific private location. A public location, and the data associated with it, is available as “read only” by all tasks and processors 25.

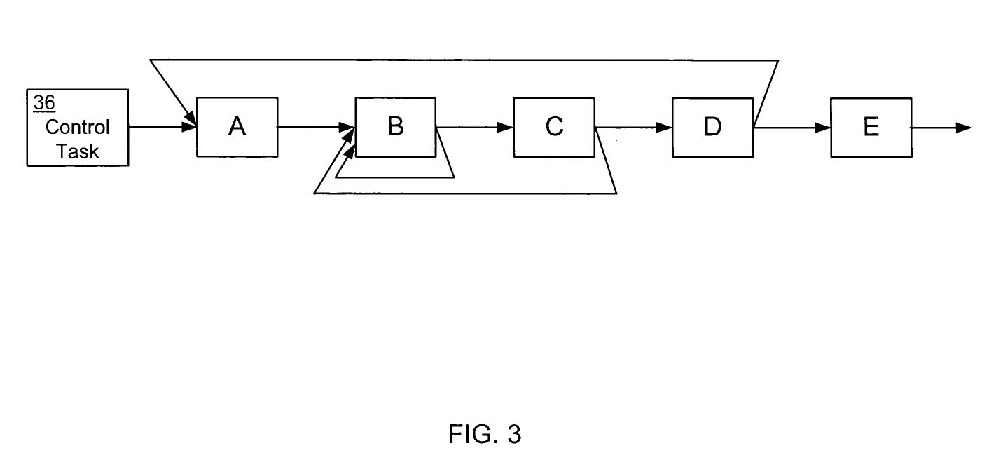

FIG. 3 illustrates one example of the computer program illustrated in FIG. 2 that has been modified to operate using the VPMS system 20. A control task 36 is added that is executed, or “runs” on the master processor 24. The control task 36 includes information on the dynamic execution of the computer program. That is, the control task 36 includes information about the control flow graph (CFG) for the program. For example, the CFG may include instructions for the VMPS management unit (VPMS-MU) 34, for the volatile program memory space (VPMS) 32, and possibly instructions for the processors 24, 25. Generally, the control task 36 dictates which task, or instruction should be dispatched according to the requirements of the program. In one embodiment, when each task arrives from the master processor 24 its source indexes are translated index to index according to a set of availability rules.

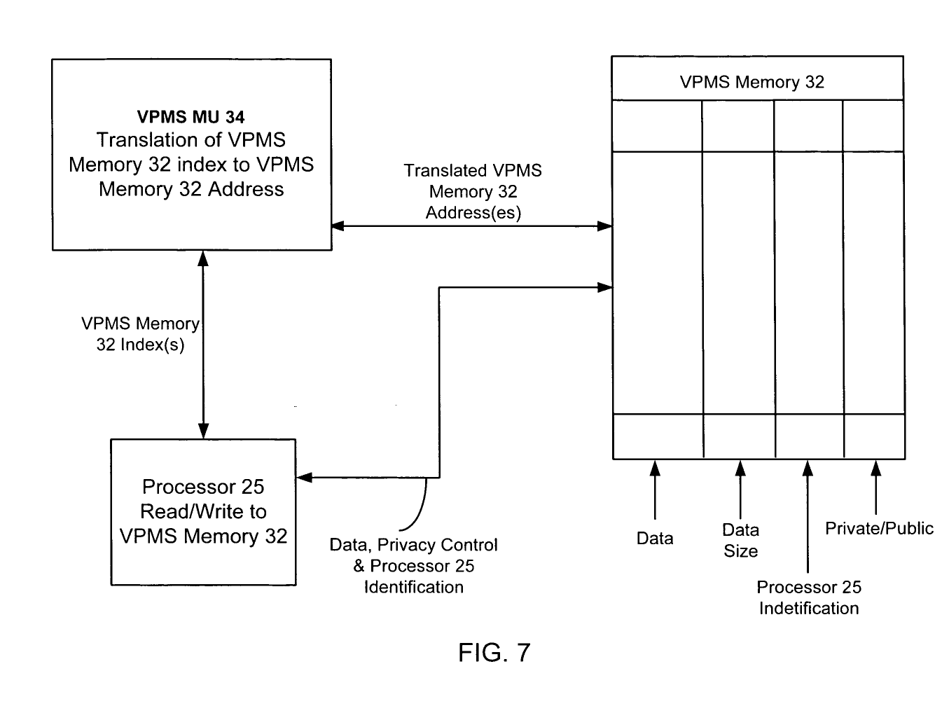

Referring back to FIG. 1, the master processor 24 accesses the control task 36 identifier codes and dispatches the task commands to the VPMS management unit 34 (VPMS-MU), or management device, for analyzing and generating new task commands. The control task identifier codes may include information about task identification, indexes of source data in the VPMS memory 32, indexes of the destination locations in the VPMS memory 32, and other information. The VPMS-MU 34 sends tasks, or instructions to one or more of the available processors 25 through the processor interconnect 38. The VPMS-MU 34 also gets data in and out of the VPMS memory, or volatile memory 32. Communication between, and among the master processor 24, the VPMS-MU 32, the VPMS memory 32, the processors 25 and other components of the VMPS system 20 is accomplished by a communication bus or other type of communication device, shown as arrows in FIG. 1. As shown in FIG. 7, one embodiment of the VPMS memory 32 includes four sections, one for data, a second for the size of the data, a third for the processor 25 identification, and a fourth that designates a private or public location.

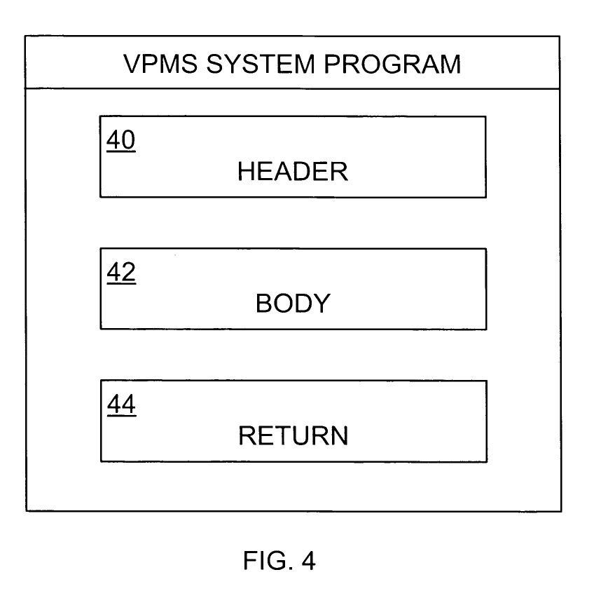

Referring now to FIG. 4, one embodiment of the VPMS system 20 includes a program structure. A programmer writing a computer program for execution by the VPMS system 20 may consider the program as having three parts. First, a header 40 that identifies the task, or instruction so the CP 24 knows what the task is and any input(s) required by the task. For example, a task identification may include a task type, one or more source locations, one or more destination locations, any conditions of execution (if any), and may also include designation for a special device to execute the task. These inputs are addressed by the VPMS memory 32 indexes, discussed above, that improve execution speed. The VPMS memory 32 indexes may include one or more columns, providing the basis for both rapid random lookups and efficient ordering of data or record access. The second part of program is the body 42 that is comprised of codes, or instructions to be executed by one or more of the processors 25. Third is the return 44 that routes the now processed, or executed instructions back to the VPMS management unit (VPMS-MU) 34.

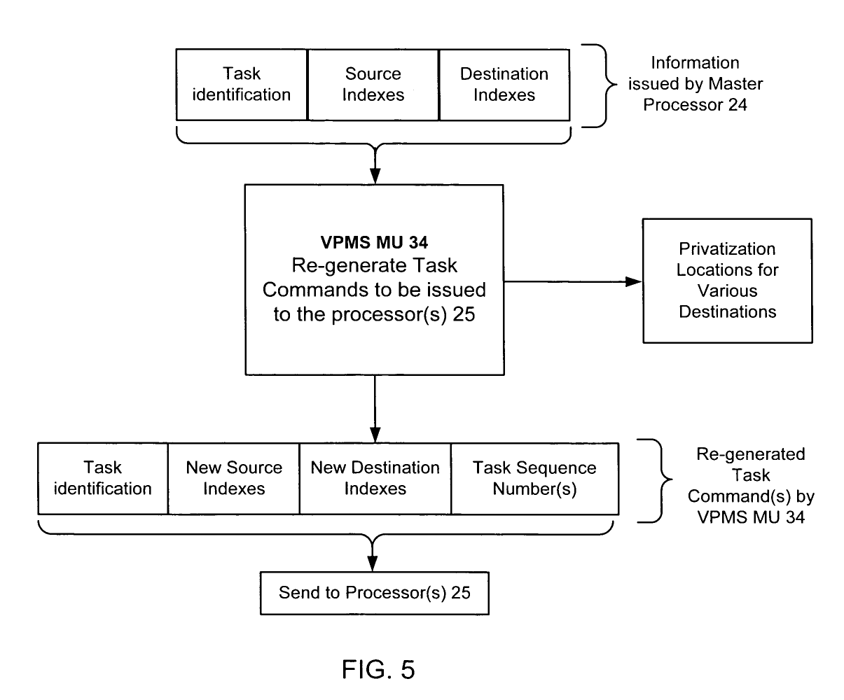

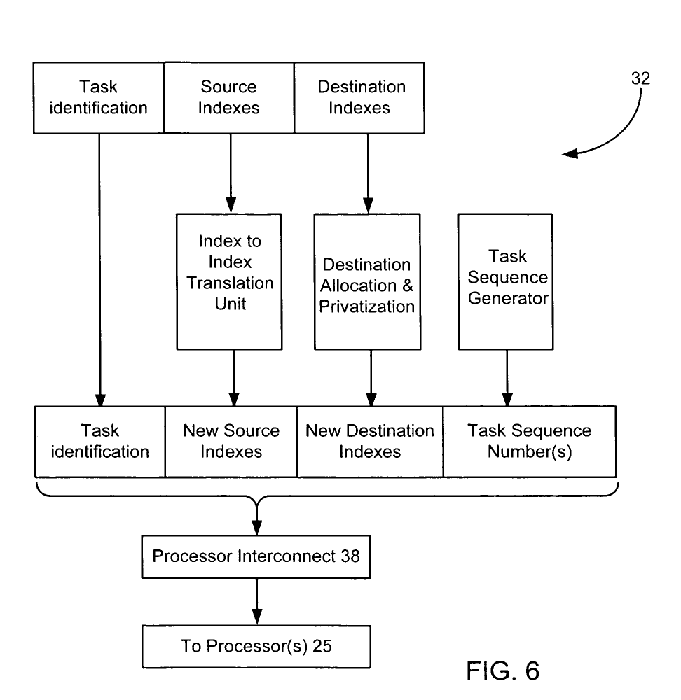

Referring now to FIGS. 5 and 6, which illustrate the information issued by the master processor, or CP 24, and the operation of the VPMS-MU 32. Using the information contained in the control task 36, the CP 24 issues task identifications, VPMS memory 32 source indexes needed to execute this specific task, and VPMS memory 32 destination indexes that receive the executed instructions, data, or results. The information issued by the CP 24 is passed to the VPMS-MU 32, which translates the destination and source indexes to new VPMS memory 32 destination and source indexes and also employs a task sequence generator to create task sequence numbers to insure sequential order, or execution of the tasks.

FIG. 7 illustrates the flow of data when a processor 25 needs to read data from VPMS memory 32 or write data to VPMS memory 32. Whenever a processor 25 requests data it will send the appropriate VPMS memory 32 index to the VPMS-MU 34. The VPMS-MU 34 will translate the VPMS memory 32 index to a VPMS memory 32 address, which is a real physical address in the VPMS memory 32 so the processor 25 can read the correct data from VPMS memory 32. Similarly, when the processor 25 writes data to a VPMS memory 32 physical address it sends a VPMS memory 32 index to the VPMS-MU 34 so that the index can later be translated to a real physical address in VPMS memory 32. In addition, when writing to VPMS memory 32, the processor 25 may also include the processor 25 identification with authority to release the VPMS memory 32 physical address and make it public.

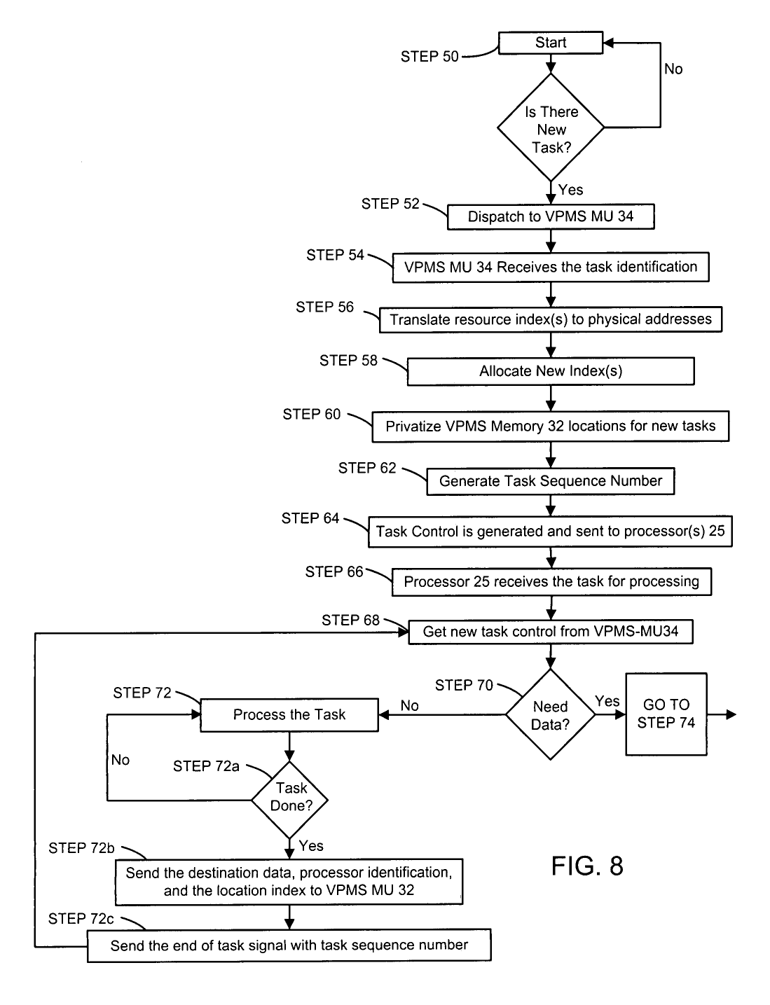

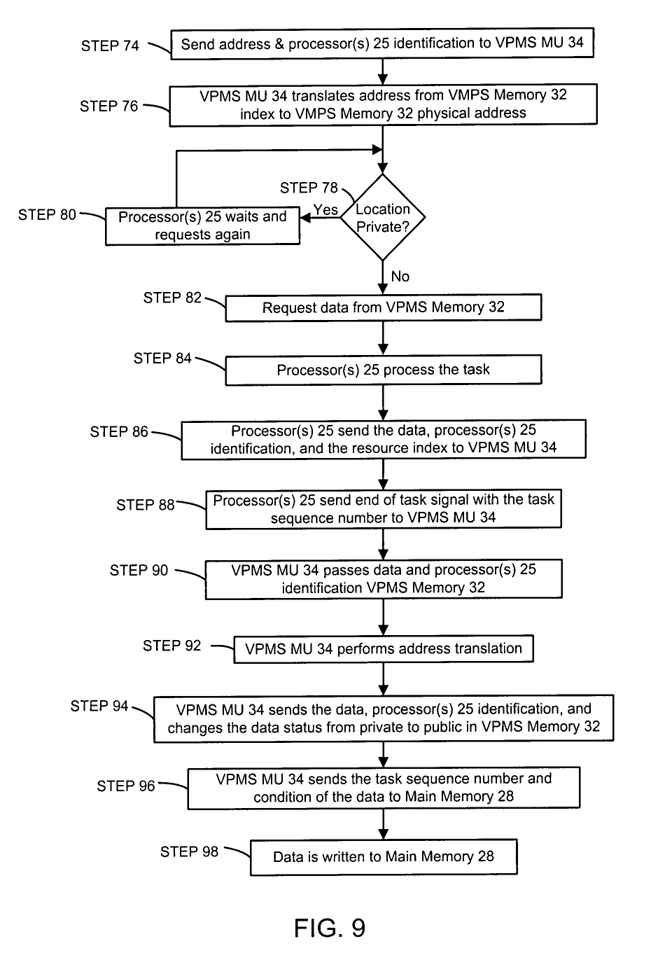

Referring now to FIGS. 8 and 9, the steps performed by the VPMS system 20 will be described. In step 50, when the CP 24 receives processing instructions (i.e., a new task) it passes the instructions to the VPMS-MU 34 in step 52, and in step 54 the VPMS-MU 34 receives a task identification, or task identifier code from the CP 24. In step 56, the VPMS-MU 34 translates the VPMS memory 32 indexes to VPMS memory 32 physical addresses which were used or generated by the CP 24 write operations. Thus, the new VPMS memory 32 physical addresses replace the VPMS memory 32 indexes. In step 58, the VPMS-MU 34 allocates, for each VPMS memory 32 physical address assigned to receive processing results, a new VPMS memory 32 index location. This prevents any damage to data which has not yet been used. In addition, this prevents two hazards from occurring: write after write (WAW) and write after read (WAR) errors. Preferably, steps 54-58 are performed on task level data and/or on large portions of data. For example, task level data generally is in order of 64 bytes or more, which generally is not instruction level or register level data. However, smaller or larger amounts of data may be manipulated in steps 54-58. In step 60, VPMS-MU 34 marks the locations assigned to each task as a private one. This prevents any read operation(s) from the location, which prevents the occurrence of WAR hazards.

In step 62, the VPMS-MU 34 assigns a sequence number to the task identifier before releasing it to processor(s) 25 in step 64, and in step 66, the processor(s) 25 receive the task for processing. The sequence number maintains the sequential order of the program, which enables multiple processors to execute a computer program without errors. When the task is completed the data in VPMS memory 32 will be ready to move back into the main memory 28. This is how the main memory 28 is kept simple, thereby enabling a computer programmer to write a program using conventional sequential execution methods, yet allowing the program to be run, or executed non-sequentially using a multi-processor architecture, such as MPSoC. The sequence number may have a limit equal to the maximum number of tasks that can be executed by the VPMS system 20. Thus, the sequence number becomes implementation dependent. As a result the sequence number may be calculated by the system developer, or computer programmer.

In step 68, the VPMS-MU 34 generates a new task control command by replacing the source and destination indexes with new source and destination indexes and appending the task sequence number to each new source and destination index.

In step 70, one or more of the processors 25 receive the task command and determine if any data from VPMS memory 32 is required. If no additional data is required, the processor(s) 25 execute the task in steps 72a-c. In step 72a, the processor(s) 25 determine if the task is complete, and if so, in step 72b, the processor(s) 25 send the destination data, processor(s) 25 identification and the location index to VPMS-MU 32. And, in step 72c, the processor(s) 25 send an end of task signal with the task sequence number to the VPMS-MU 32.

If there is a need for additional data, the processor(s) 25 send the physical address, and the processor(s) 25 identification to the VPMS-MU 34 in step 74.

In step 76, the VPMS-MU 34 receives the request for additional data from the processor(s) 25, and performs an address translation from the VPMS memory 32 index to the VPMS memory 32 physical address. In step 78, the VPMS-MU 34 checks if the physical location addressed is private. In step 80, if the location is private the VPMS-MU 34 will send a wait signal to the requesting processor(s) 25. In step 82, if the location is public the VPMS-MU 34 will check if the processor(s) 25 identification stored with the data at the physical address in VPMS memory 32 matches the requesting processor(s) 25 identification. The VPMS-MU 34 will then determine the size of the data. If the size of the data is small enough, the VPMS-MU 34 will instruct VPMS memory 32 to send the data to the processor(s) 25. If the data is large the VPMS-MU 34 will instruct the VPMS memory 32 to send a small amount along with a signal telling the requesting processor(s) 25 it may have the data. These steps increase performance of the VPMS system 21. Generally, large data is an amount of data that requires more than one data transfer cycle as established by the VPMS system 20 design and configuration.

In step 84, the processor(s) 25 receive the data and then determine if they have all the data. If they do then the processor(s) 25 will try to execute the task without waiting for the rest of the data. If the processor(s) 25 do not have a sufficient amount of data in their possession they will ask VPMS-MU 34 for the remaining data, which it obtains from VPMS memory 32. This way the processor(s) 25 saves time not waiting for redundant data. When all the necessary data becomes available the processor(s) 25 executes the task according to the task codes. In step 86, once the processor(s) 25 finishes the task, or if the task is halted for any reason, the processor(s) 25 sends the data, the processor identification and the VPMS memory 32 index to VPMS-MU 34. In addition, in step 88, the processor(s) 25 sends an end of task signal with the task sequence number to the VPMS-MU 34.

In step 90, the VPMS-MU 34 will receive the data and processor(s) 25 identification to pass them to the VPMS memory 32. In step 92, the VPMS-MU 34 performs an address translation from VPMS memory 32 index to VPMS memory 32 physical address. In step 94, the VPMS-MU 34 sends, or writes the data in a data location, and also sends, or writes the processor(s) 25 identification in the processor(s) 25 identification location, marks the size of the data, and then changes the location from private to public so that the data can be read by other tasks.

In addition, the processor(s) 25 may, at the end of the task, send a sequence number along with the task conditions. For example, the task conditions may include information about how the task ended, such as, if it was completed or if it was halted, does the task data contain errors, interrupts, etc.

In step 96, the VPMS-MU 34 receives the task sequence number and the task conditions. If the task ended normally the data will become available to be written to the main memory 28. In this way main memory 28 is kept safe and simple.

One embodiment of the VPMS system 20 moves data between main memory 28 and VPMS memory 32 as follows: Generally, every task needs data to process. At the beginning of a computer program execution, data is retrieved from main memory 28 where the original computer program is stored. For every task that needs data, that task generally uses another task that loads data from main memory 28 to a specific location in the VPMS memory 32. The task then later retrieves the data from VPMS memory 32 for processing. Once the task produces a result it delivers the data to VPMS memory 32 according to the task requirements, and the above description. Eventually the data in the VPMS memory 32 is stored in the main memory 28 for use. Thus, in one embodiment a special store task is contained in the computer program to store the data from VPMS memory 32 to the main memory 28.

For example, when a task arrives at the master processor, or CP 24, it includes a main memory 28 address that contains data. The address is translated by the main processor 24 from a virtual address to a physical location address. The physical location address is sent with the task to VPMS-MU 34. VPMS-MU 34 receives the load task and processes it like all other tasks, with the exception of translating the physical location address. VPMS-MU 34 sends the task to the memory management unit (MMU) 30 for execution. The MMU 30 reads the data from main memory 28 or if the computer uses a cache memory, the MMU 30 will read the data from the cache memory. Then the MMU 30 sends the data to be loaded in the desired location in the VPMS memory 32.

For storing data from VPMS memory 32 to the main memory 28, the VPMS system 20 employs a store task which contains the input from VPMS memory 32 and the output to main memory 28. The store task is first processed by the master processor 24 for virtual address to physical address translation then the physical address is appended to the task header. The store task is then sent to VPMS-MU 34 like other tasks, and is processed like other tasks. The VPMS-MU 34 then sends the task control to the MMU 30 that reads the data from VPMS memory 32 and stores the data in the main memory 28.

In the VPMS system 20, both the load and store tasks return the task end signals to VPMS-MU 34 for ordering the sequence of operations like any other task. Thus, the VPMS system 20 keeps the same sequential programming model as employed by a single-processor. This allows programmers to write sequential programs that can be executed in parallel fashion on a multi-processor computer.

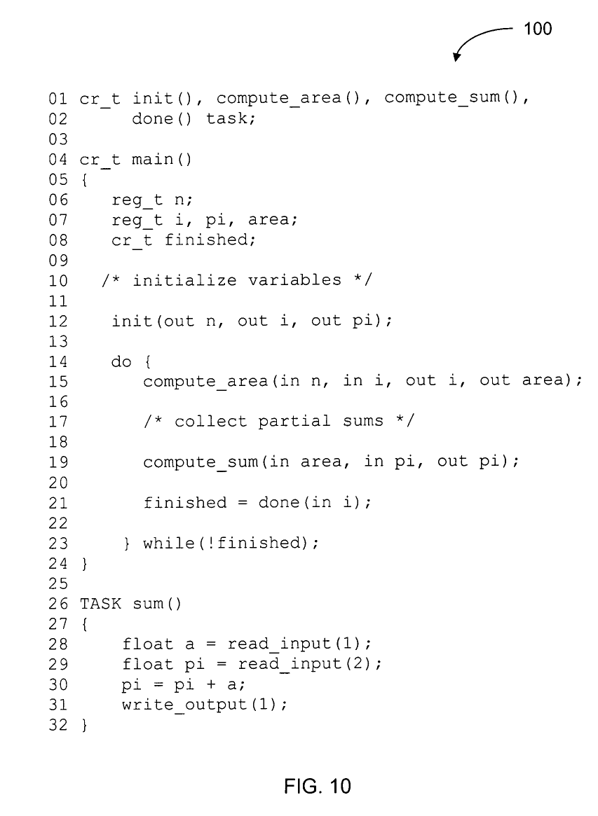

For example, as shown in FIG. 10 is one embodiment of a computer program 100 using the VPMS system 20. The computer program 100 provides a calculation of the value of π which is approximated by a sum of areas below the curve as shown in the below integral:

$$π = {\int }_{0}^{1} \frac{4}{1 + {x}^{2}} d x$$

Using the “C” computer programming language, lines 01 and 02 declare the tasks init( ), sum( ), compute( ) and done( ) are tasks for returning a control register type (cr_t). The main program starts at line 04. In lines 06 and 07, variables i, n, pi, and area are declared, with the content of each variable stored in VPMS memory 32. Interval [0 1] is divided in n slices, and “I” is the index of the current slice. In line 08, a control variable is finished, the value of which will decide when to exit the loop.

On line 12, the init( ) task initializes the value of the listed variables. On line 14, to the beginning of a loop that ends at line 23 is a test to decide whether the loop is finished or not. The loop has three main parts: on line 15, the area for a given index is computed, line 19 performs the accumulation of areas in pi and line 21 decides when the loop is finished.

Each task (sum, area, done) is executed using a processor 25. The master processor or CP 24 sends the value of the input variables to VPMS MU 34 which reserves a space in VPMS memory 32 for the output of each task.

All of the above operations may be performed sequentially. That is, one feature of the VPMS system 20 is that the above computer program does not contain any explicit expression of parallelism, unlike conventional threaded parallel processing computer programs. Unlike OpenMP, MPI and other parallel computing techniques, the data dependencies inside the loop (between variables area and pi) are all explicit. As a result, the VPMS system 20 will enable the development of compilers for multiprocessor programs.

Using a data dependency analysis, if a new destination is allocated every time, multiple instances of the area( ) task will run in parallel on different processors 25. The amount of parallelism obtained when running this program will generally depend on the availability of resources (computing elements, access times and throughput of main memory 28, VPMS memory 32, etc), and not how much parallelism was written into the program by the programmer.

Also, data dependencies between tasks (for example, area is an output of compute_area( ) and an input of compute_sum( )) allows a “synchronization” between these tasks without the need for explicit statements or semaphores, mutexes, etc., further simplifying the computer programmers job. That is, the above program illustrates how the VPMS system 20 enables a sequential programming model that can be easily grasped and employed by a computer programmer, yet the resulting program can be “run” in a parallel fashion on a multiprocessor computer. Put differently, the number of processors 24 and 25 are irrelevant to the computer programmer.

Another feature of the VPMS system 20 is that it enables improved computer system security and authenticity by using the processor identification to prevent undesirable programs from execution and also prevents such programs from accessing the master processor 24.

Another embodiment of the VPMS system 20 may employ multiprogramming methods, or techniques by creating multiple VPMS memories 32. Another embodiment of the VPMS system 20 may issue multiple tasks at once to increase performance. Yet another embodiment of the VPMS system 20 may use methods of speculative task execution. A further embodiment of the VPMS system 20 may use massively connected computers to solve computationally intensive problems. Another embodiment of the VPMS system 20 may use redundant processors and rearrange VPMS-MU 34 for designing fault-tolerance computers.

Another embodiment of the VPMS system 20 may employ a novel compilation method. In one embodiment, compilation may be constructed using two levels, one level of compilation for the Control Graph flow (CGF) level to run on the master processor 24, and the second level for individual processor(s) 25.

Another embodiment of the VPMS system 20 may be employ system synthesis. That is, because the VPMS system 20 enables processing and programs to be written as if they will be executed on a single processor, the VPMS system 20 may synthesize systems as we do for single microprocessors.

Yet another embodiment of the VPMS system 20 may comprise an apparatus to isolate a main memory in a multiprocessor computer that includes a master processor, a management device communicating with the master processor, one or more slave processors communicating with the master processor and the management device, a volatile memory communicating with the management device, with the main memory communicating with the volatile memory. The multiprocessor computer executes a program encoded on a readable medium, the program comprising a header comprising a task identifier, a program body including a task code, and an end of program section, and the master processor forwards the task code to the management device according to a control flow graph. In addition, the management device may generate a sequential order of the program encoded on a readable medium by issuing a task sequence number to each of a plurality of tasks in the program, and orders the plurality of tasks into a plurality of task sequence numbers.

Generally, each task is executed by the one or more slave processors, and the slave processor sends an end of task signal to the management device with a slave processor identification and the task sequence number. One feature of this embodiment is that the master processor executes a program encoded on a readable medium, the program comprising a control task that comprises a control flow graph that includes information on a dynamic execution of the program encoded on the readable medium that permits an out-of-order execution sequence while preserving a sequential correctness of the program encoded on the readable medium. Also, the task identifier includes information on the task code and a location of the task code in the volatile memory, with the task code addressed by at least one index, the task code comprised of data.

In this embodiment, the volatile memory separates the main memory from the master processor, and stores data that is addressed by at least one index, and the management device assigns a destination in the volatile memory to a task result, and translates the index into a volatile memory physical address. Generally, the volatile memory may be comprised of at least four sections comprising a data location, a data location size indicator, a slave processor identifier that indentifies the slave processor that deposited data in the data location, and a data identifier that identifies whether the data is a private data type or a public data type.

In general, the private data type is accessible only by the slave processor, and the public data type is accessible by all processors, and the management device reads public data from the volatile memory, and waits to read private data until it becomes public data.

In addition, the management device receives the index from the slave processor and translates the index into a volatile memory physical address, and then requests the data from the volatile memory, and sends a plurality of load and store tasks to a memory management unit. Also in this embodiment, the master processor executes a program encoded on a readable medium, the program may include a control task that forwards a plurality of tasks to the one or more slave processors in an out-of-order sequence while preserving a correctness of a sequentially specified program encoded on a readable medium.

Yet another embodiment of the VPMS system 20 may comprise a computer program product in a computer readable medium for use with a multiprocessor computer system comprising a configuration of hardware components. The computer program product may include the steps of scheduling a plurality of tasks for execution by one or more processors, dispatching the plurality of tasks to the one or more processors according to the scheduling, and executing the plurality of tasks within the one or more processors, wherein each processor communicates with a management device and a volatile memory, and each processor does not communicate with a main memory of the multiprocessor computer.

In this embodiment, a management device forwards the plurality of tasks to the one or more processors in an out-of-order sequence while preserving a correctness of a sequentially specified program encoded on a readable medium that is capable of being executed by a multiprocessor computer. In addition, the management device forwards a result of the plurality of tasks from the volatile memory to the main memory upon a task completion.

Also, the management device generates a sequential order of the program encoded on a readable medium by issuing a task sequence number to each of a plurality of tasks in the program, and orders the plurality of tasks into a plurality of task sequence numbers, where each task is executed by the one or more processors, and the processor sends an end of task signal to the management device with a processor identification and the task sequence number.

In this embodiment, the computer program product comprises a control task that comprises a control flow graph that includes information on a dynamic execution of the computer program product that permits an out-of-order execution sequence while preserving a sequential correctness of the computer program product.

Yet another embodiment of the VPMS system 20 may comprise a computer program product that includes a multiprocessor computer useable medium having a processor readable code embodied therein to generate instructions to perform a task, with the a computer program product including computer code that generates a plurality of task identifications, a plurality of volatile memory source indexes to execute the task, and a plurality of volatile memory destination indexes that receive task data and computer code that translates the plurality of the volatile memory destination and source indexes to a plurality of new volatile memory destination and source indexes and a task sequence generator that creates a plurality of task sequence numbers to maintain a sequential order of the task.

In this embodiment, the plurality of task identifications, the plurality of volatile memory source indexes, the plurality of volatile memory destination indexes, and the plurality of new volatile memory destination and source indexes are located in a volatile memory that is not a main memory in the multiprocessor computer. This embodiment further comprises computer code to move the task data from the volatile memory to the main memory upon a task completion, where the task comprises a plurality of instructions for executing a computer program, and the plurality of task identifications are selected from a group consisting of a task type, a source location, a destination location, and a condition of execution.

Also in this embodiment, the plurality of volatile memory source indexes and the plurality of volatile memory destination indexes comprise a plurality of volatile memory locations that contain task data, where the task is executed by one or more slave processors, and the slave processor sends an end of task signal with a slave processor identification and the task sequence number to a management device.

The following discussion is intended to provide a brief, general description of a suitable computing environment in which the VPMS system 20 may be implemented. Although not required, the VPMS system 20 is described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the VPMS system 20 may be practiced with other computer system configurations, including hand-held devices, programmable consumer electronics, network PCs, minicomputers, mainframe computers, and the like. The VPMS system 20 may also be practiced in distributed computing environments where tasks are performed by remote processing devices that are linked through a communications network. In a distributed computing environment, program modules may be located on both local and remote memory storage devices.

For example, an exemplary system for implementing the VPMS system 20 may include a general purpose computing device in the form of a conventional personal computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The personal computer may further include a hard disk drive for reading from and writing to a hard disk, a magnetic disk drive for reading from or writing to a removable magnetic disk, and an optical disk drive for reading from or writing to a removable optical disk such as a CD ROM or other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of computer readable instructions, data structures, program modules and other data for the personal computer. Although the exemplary environment described herein employs a hard disk, a removable magnetic disk and a removable optical disk, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary operating environment.

A number of program modules may be stored on the hard disk, magnetic disk, including an operating system, one or more application programs, other program modules, and program data. A user may enter commands and information into the personal computer through input devices such as a keyboard and pointing device. Other input devices may include a microphone, joystick, game pad, satellite dish, scanner, or the like. These and other input devices are often connected to the processing unit through a serial port interface that is coupled to the system bus, but may be connected by other interfaces, such as a parallel port, game port or a universal serial bus (USB). A monitor or other type of display device is also connected to the system bus via an interface, such as a video adapter. In addition to the monitor, personal computers typically include other peripheral output devices, such as speakers and printers.

The personal computer may operate in a networked environment using logical connections to one or more remote computers, such as a remote compute. The remote computer may be another personal computer, a server, a router, a network PC, a peer device or other common network node, and typically includes many or all of the elements described above relative to the personal computer.

As will be appreciated by one of skill in the art, embodiments of the VPMS system 20 may be provided as methods, systems, or computer program products. Accordingly, the VPMS system 20 may take the form of an entirely hardware embodiment, an entirely software embodiment or an embodiment combining software and hardware aspects. Furthermore, the VPMS system 20 may take the forn of a computer program product which is embodied on one or more computer-usable storage media (including, but not limited to, disk storage, CD-ROM, optical storage, and so forth) having computer-usable program code embodied therein.

The VPMS system 20 has been described with reference to flowchart illustrations and/or block diagrams of methods, apparatus (systems) and computer program products according to different embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Thus, it is seen that a VPMS system 20 is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. An apparatus to isolate a main memory in a multiprocessor computer, comprising:
a master processor;
a management device communicating with the master processor;
one or more slave processors communicating with the master processor and the management device;
a volatile memory communicating with the management device; and
the main memory communicating with the volatile memory.

2. The apparatus of claim 1, where the multiprocessor computer executes a program encoded on a readable medium, the program comprising a header comprising a task identifier, a program body including a task code, and an end of program section.

3. The apparatus of claim 2, where the master processor forwards the task code to the management device according to a control flow graph.

4. The apparatus of claim 3, where the management device generates a sequential order of the program encoded on a readable medium by issuing a task sequence number to each of a plurality of tasks in the program, and orders the plurality of tasks into a plurality of task sequence numbers.

5. The apparatus of claim 4, where each task is executed by the one or more slave processors, and the slave processor sends an end of task signal to the management device with a slave processor identification and the task sequence number.

6. The apparatus of claim 1, where the master processor executes a program encoded on a readable medium, the program comprising a control task that comprises a control flow graph that includes information on a dynamic execution of the program encoded on the readable medium that permits an out-of-order execution sequence while preserving a sequential correctness of the program encoded on the readable medium.

7. The apparatus of claim 2, where the task identifier includes information on the task code and a location of the task code in the volatile memory, with the task code addressed by at least one index, the task code comprising data.

8. The apparatus of claim 1, where the volatile memory separates the main memory from the master processor, and stores data that is addressed by at least one index.

9. The apparatus of claim 7, where the management device assigns a destination in the volatile memory to a task result, and translates the index into a volatile memory physical address.

10. The apparatus of claim 1, where the volatile memory comprises at least four sections comprising a data location, a data location size indicator, a slave processor identifier that indentifies the slave processor that deposited data in the data location, and a data identifier that identifies whether the data is a private data type or a public data type.

11. The apparatus of claim 10, where the private data type is accessible only by the slave processor, and the public data type is accessible by all processors.

12. The apparatus of claim 11, where the management device reads public data from the volatile memory, and waits to read private data until it becomes public data.

13. The apparatus of claim 7, where the management device receives the index from the slave processor and translates the index into a volatile memory physical address, and then requests the data from the volatile memory.

14. The apparatus of claim 4, where the management device sends a plurality of load and store tasks to a memory management unit.

15. The apparatus of claim 1, where the master processor executes a program encoded on a readable medium, the program comprising a control task that forwards a plurality of tasks to the one or more slave processors in an out-of-order sequence while preserving a correctness of a sequentially specified program encoded on a readable medium.

16. A computer program product in a computer readable medium for use with a multiprocessor computer system comprising a configuration of hardware components, the computer program product comprising the steps of:
scheduling a plurality of tasks for execution by one or more processors;
dispatching the plurality of tasks to the one or more processors according to the scheduling; and
executing the plurality of tasks within the one or more processors, wherein each processor communicates with a management device and a volatile memory, and each processor does not communicate with a main memory of the multiprocessor computer.

17. The computer program product of claim 16, where a management device forwards the plurality of tasks to the one or more processors in an out-of-order sequence while preserving a correctness of a sequentially specified program encoded on a readable medium that is capable of being executed by a multiprocessor computer.

18. The computer program product of claim 17, where the management device forwards a result of the plurality of tasks from the volatile memory to the main memory upon a task completion.

19. The computer program product of claim 16, where the management device generates a sequential order of the program encoded on a readable medium by issuing a task sequence number to each of a plurality of tasks in the program, and orders the plurality of tasks into a plurality of task sequence numbers.

20. The computer program product of claim 16, where each task is executed by the one or more processors, and the processor sends an end of task signal to the management device with a processor identification and the task sequence number.

21. The computer program product of claim 16, where the computer program product comprises a control task that comprises a control flow graph that includes information on a dynamic execution of the computer program product that permits an out-of-order execution sequence while preserving a sequential correctness of the computer program product.

22. A computer program product comprising:
a multiprocessor computer useable medium having a processor readable code embodied therein to generate instructions to perform a task, comprising:
computer code that generates a plurality of task identifications, a plurality of volatile memory source indexes to execute the task, and a plurality of volatile memory destination indexes that receive task data;
computer code that translates the plurality of the volatile memory destination and source indexes to a plurality of new volatile memory destination and source indexes and a task sequence generator that creates a plurality of task sequence numbers to maintain a sequential order of the task.

23. The computer program product for generating machine instructions of claim 22, where the plurality of task identifications, the plurality of volatile memory source indexes, the plurality of volatile memory destination indexes, and the plurality of new volatile memory destination and source indexes are located in a volatile memory that is not a main memory in the multiprocessor computer.

23. The computer program product for generating machine instructions of claim 23, further comprising computer code to move the task data from the volatile memory to the main memory upon a task completion.

24. The computer program product for generating machine instructions of claim 22, where the task comprises a plurality of instructions for executing a computer program.

25. The computer program product for generating machine instructions of claim 22, where the plurality of task identifications are selected from the group consisting of: a task type, a source location, a destination location, and a condition of execution.

26. The computer program product for generating machine instructions of claim 22, where the plurality of volatile memory source indexes and the plurality of volatile memory destination indexes comprise a plurality of volatile memory locations that contain task data.

27. The computer program product for generating machine instructions of claim 22, where the task is executed by one or more slave processors, and the slave processor sends an end of task signal with a slave processor identification and the task sequence number to a management device.
